(19) United States
(12) Patent Application Publication
(10) Pub. No.: US 2020/0156182 A1
(43) Pub. Date: May 21, 2020

(54) APPARATUS FOR EXCESS HEAT GENERATION

(71) Applicant: IH IP HOLDINGS LIMITED, St. Helier (JE)

(72) Inventor: Tadahiko Mizuno, Sapporo-shi Hokkaido (JP)

(21) Appl. No.: 16/747,164

(22) Filed: Jan. 20, 2020

Related U.S. Application Data
(63) Continuation of application No. PCT/IB18/00920, filed on Jul. 20, 2018.
(60) Provisional application No. 62/534,762, filed on Jul. 20, 2017.

(51) Int. Cl. B23K 20/16; G21B 1/17

(52) U.S. Cl. CPC B23K 20/165; H01J 49/42; G21B 1/17

(57) ABSTRACT

The present application discloses an exemplary exothermic reaction system that is configured to generate excess heat. Also disclosed is a set of procedures for preparing and operating the exothermic reaction system. A Residual Gas Analyzer (RGA) or a similar device such as a quadruple mass spectrometer is employed to ensure that each step in the set of procedures is complete before moving to the next step. The detailed steps in how to assemble and clean the exothermic reaction system are described along with the RGA test results that are used as calibration baseline.

### CROSS-REFERENCE TO RELATED APPLICATIONS

This application is a continuation of International Application No. PCT/IB2018/000920, filed on Jul. 20, 2018, entitled “APPARATUS FOR EXCESS HEAT GENERATION”, which claims priority to U.S. Provisional Patent Applications No. 62/534,762 filed on Jul. 20, 2017, entitled APPARATUS FOR EXCESS HEAT GENERATION, the contents of which are incorporated by reference herein.

### TECHNICAL AREA

The present disclosure relates to exothermic reactors configured for excess heat generation.

### BACKGROUND

Over the past several decades, excess heat generation phenomena have been observed under different settings and in different systems. Generally, an excess heat generation system comprises a transition metal or alloy loaded with hydrogen or deuterium. In certain cases and under certain conditions, the amount of output power significantly exceeded the amount of input power used for operating the heat generation system. In many of those reported cases, the amount of excess heat generated couldn't be explained by electro-chemical or pure chemical reactions. However, attempts to reproduce reported experiments have often failed. Experiments of excess heat generation have long been plagued by lack of reproducibility and lack of consistency.

There is a need for designing and manufacturing a commercially viable excess heat generation system that is both reliable and efficient.

### SUMMARY

The present disclosure teaches exemplary methods and apparatus for excess heat generation. An exemplary apparatus configured for excess heat generation comprises a vessel and two electrodes: an anode and a cathode. The vessel comprises a gas inlet and a gas outlet. The gas inlet is configured for supplying one or more gases to the vessel. The gas outlet is used for gas evacuation. One of the electrodes, e.g., the anode, is made of a first transition metal.

In one embodiment, one of the electrodes is made of nickel. In yet another embodiment, one of the electrodes is in the shape of a mesh. The second electrode, e.g., the cathode, is made of a second transition metal that is wound with a wire made of a third transition metal. In one embodiment, the cathode is made of nickel. In yet another embodiment, the cathode is in the shape of a rod wound with a metal wire, e.g., a palladium wire.

In some embodiments, the first or second transition metal comprises one or more of the following metals: titanium (Ti), zirconium (Zr), hafnium (Hf), chronium (Cr), vanadium (V), niobium (Nb), tantalum (Ta), molybdenum (Mo), tungsten (W), iron (Fe), ruthenium (Ru), rhodium (Rh), iridium (Jr), nickel (Ni), palladium (Pd), platinum (Pt), copper (Cu), silver (Ag), gold (Au), zinc (Zn), aluminum (Al), indium (In), and tin (Sn). In one embodiment, the first or second transition metal may be an alloy of two or more metals listed above. In some preferred embodiments, the first and second transition metal are selected from titanium, nickel, palladium platinum, and an alloy thereof.

In preparing the apparatus for an exothermic reaction, the apparatus is first assembled, then cleaned and activated for operation. Once activated, a metallic structure made of the third transition metal may be deposited on the anode. In some embodiments, the metallic structure may be a thin film. In other embodiments, the metallic structure may comprise nanoparticles.

In some embodiments, the apparatus is calibrated before operation. During calibration, the vessel in the apparatus is degassed first. The vessel is then filled with a helium gas to a first pressure and heated to a plurality of test temperatures. Under each test temperature, the pressure is measured and recorded. When the calibration is finished, the helium gas is evacuated. In other embodiments, argon or vacuum may be used for calibration. In yet another embodiment, calibration is carried out in the flow of a calibration gas, e.g., argon, helium, or hydrogen.

During operation, the temperature and pressure inside the vessel are maintained at pre-determined levels to provide an optimal operating environment for the apparatus. The anode and cathode are connected to a power supply to provide a voltage differential between the two electrodes. The temperature, pressure, and/or the voltage differential between the anode and the cathode are system parameters of the apparatus and can be configured to provide a triggering condition to initiate an exothermic reaction inside the vessel. Once initiated, the exothermic reaction inside the apparatus may be sustained for hours or days for excess heat generation.

### DESCRIPTION OF DRAWINGS

FIG. 1 illustrates an exemplary exothermic reactor.

FIGS. 2A-2E illustrate different components of an exemplary exothermic reactor system.

FIG. 3 illustrates an exemplary operation procedure for preparing and operating an exothermic reactor system.

FIG. 4 illustrates an exemplary assembling procedure of an exothermic reactor system.

FIG. 5 illustrates an exemplary cleaning procedure of an exothermic reactor system.

FIG. 6 is an RGA graph illustrating the composition of a background gas.

FIG. 7 is an RGA graph illustrating the composition of a sample of deuterium gas.

### DETAILED DESCRIPTIONS

The present application relates to exothermic reactions and exemplary apparatus that can be configured for excess heat generation.

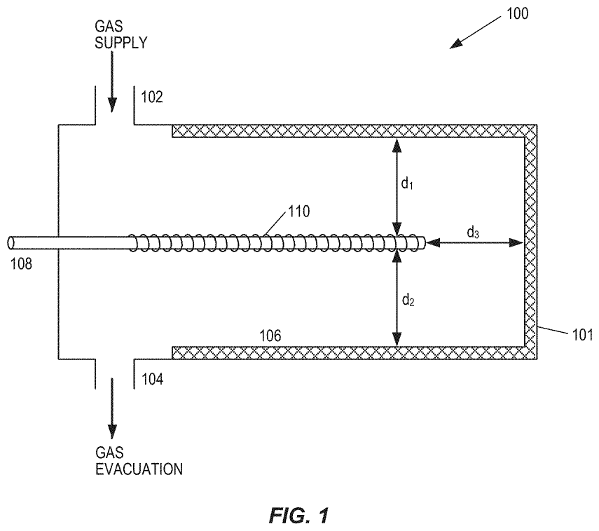

FIG. 1 illustrates an exemplary apparatus that can be configured as an exothermic reactor 100 for excess heat generation. The exothermic reactor 100 in FIG. 1 comprises a vessel 101 with two openings, one opening as a gas inlet 102 for supplying one or more gases and one opening as a gas outlet 104 for extracting or evacuating one or more gases. The gas inlet 102 is used to supply reactant gases or inert gases to the vessel 101. An inert gas, such as argon, may be used to flush out reactant gases or residual gases. The inert gases may also be used to fill the apparatus during transportation and storage. The gas outlet 104 is used to extract or evacuate the gases inside the vessel 100. The gas or gases inside the vessel 101 may be extracted for real time gas analysis. Alternatively, the gases inside the vessel 101 may be evacuated to remove contaminations and/or create a strong vacuum in the vessel 101.

Although not shown, the exothermic reactor 100 in FIG. 1 also comprises one or more thermocouples for temperature measurements. Some of the thermocouples may be positioned on the outer surface of the vessel 101 or inside the vessel 101.

The exothermic reactor 100 further comprises two electrodes, an anode and a cathode. The two electrodes are connected to a power supply. In the embodiment shown in FIG. 1, the vessel 101 functions as an anode. Inside the vessel 101, a mesh 106 is placed at or near the surface of the anode, and is electrically connected to the anode. In some embodiments, the mesh 106 may be isolated from the vessel 101 and function as an anode.

In some embodiments, the mesh 106 may be made of nickel. In some embodiments, the cathode is made of a transition metal in the shape of a rod. A metal wire 110 is wound around the cathode. In some embodiments, the cathode is a nickel rod wound with a palladium wire.

In one embodiment, the vessel 101 is a stainless steel cylinder with an inner diameter of 114 mm and a length of 304 mm. The internal volume of the vessel is about 2800 cm³. In yet another embodiment, a larger vessel 101 may be constructed with an internal volume of 5530 cm³. The nickel rod that functions as the cathode is mounted axially inside the vessel 101. The nickel rod is 3.2 mm in diameter and extends axially over a substantial portion of the length of the cylinder. The nickel rod is wound with a palladium wire that is 0.3 mm in diameter and approximately 2 m in length. The grid size of the nickel mesh is approximately 100 nm and may be electrically connected to the vessel 101.

In some preferred embodiments, the vessel 101 is a cylinder, the radius of which ranges from 50 to 150 mm and the length of which ranges from 150 to 400 mm. More specifically, in certain embodiments, the radius of the vessel 101 is between 50 to 150 mm and the length of the vessel 101 is between 150 mm to 300 mm. In one embodiment, the nickel rod is of a 3 mm diameter and is 200 mm in length, the palladium wire is of a 1.0 mm diameter and the distance between the palladium wire and the nickel mesh is about 50 mm.

In FIG. 1, the nickel rod is at a distance d₁ from the top side of the wall of the vessel, a distance d₂ from the lower side of the wall of the vessel, and a distance d₃ from the bottom of the vessel. In a preferred embodiment, the three distances, d₁, d₂, and d₃, are the same. That is, the nickel rod is of equal distance to the interior walls of the vessel.

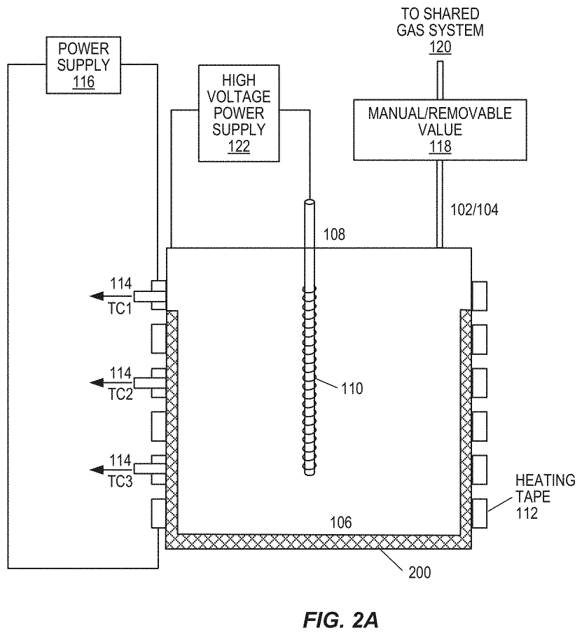

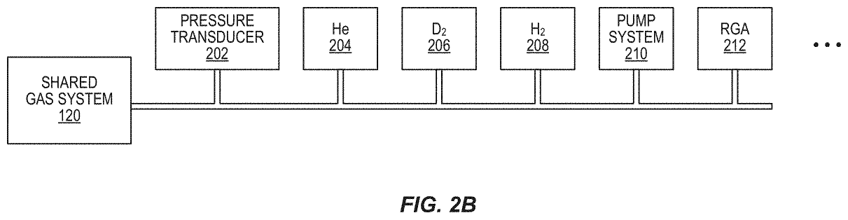

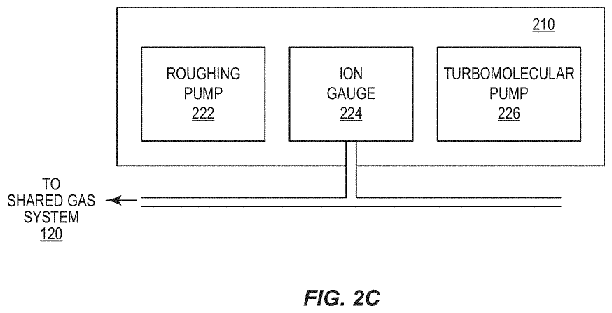

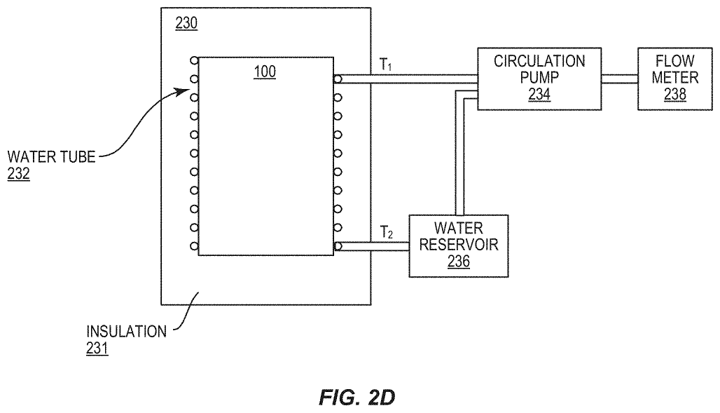

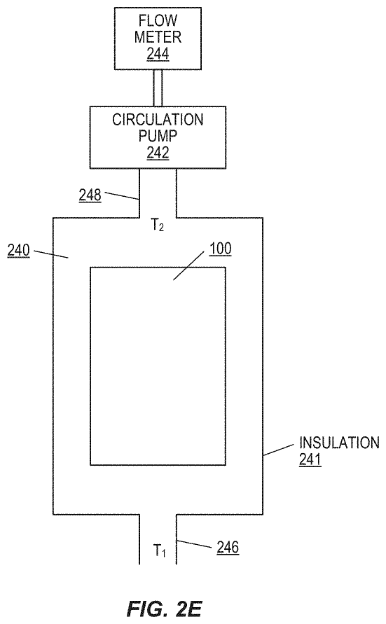

FIG. 2A is a detailed illustration of an exemplary exothermic reactor system 200 configured for exothermic reactions. The exothermic reactor system 200 comprises the apparatus 100, heating tape 112, thermocouples 114, power supply 116, gas valve 118, gas system 120, and high voltage power supply 122. The apparatus 100 is configured to house an exothermic reaction inside the vessel 101. Thermocouples 114 are placed on the outer surface of the vessel 101 and are configured to take temperature readings for calorimetrical measurements. It is noted that the placement of thermocouples is optional and the positions of the thermocouples are determined in accordance to the measurement requirements.

In FIG. 2A, the electrodes of the exothermic reactor 100 are connected to the high voltage power supply 122. The power supply 122 provides the high voltage or electric field in between the electrodes inside the vessel 101 that is required at some stages during operation of the exothermic reactor system 200.

In some embodiments, the heating tape 112 is wound around the vessel 101, for example, covering about 80% of the outer surface of the vessel 101. The heating tape 112 has a width of 5 mm and can supply an average power output of 500 W, assuming 2 liters of reactor volume. In some embodiments, the thermocouples 114 are placed underneath the heating tape 112. For instance, a thermocouple 114 is placed on the outer surface at the middle point between the two ends of the vessel 101 while two thermocouples 114, e.g., K-type thermocouples are placed near the two ends of the vessel 101. In some embodiments, the exothermic reactor system 200 may be connected to a data logger (not shown) that records the temperature measurements collected by the thermocouples 114.

In some embodiments, the heating tape 112 is wrapped in thermal insulation of a thickness, for example, 15 mm. In other embodiments, the thickness of the heating tape 112 ranges from 5 mm to 50 mm. In general, a thicker layer of thermal insulation is preferred. The thermal insulation may be held in place by any fixing means. In one embodiment, a metal wire, e.g., a copper wire, is used to tie up the thermal insulation around the heating tape 112. The heating tape 112 is connected to the power supply 116. In some embodiments, the power supply 116 can supply a power of 500 W and can maintain the heating tape at a temperature up to 850° C.

In some embodiments, an optical window may be optionally installed on the vessel 101. The optical window can be made of quartz to facilitate direct observation of the inside of the vessel 101. The optical window may be installed on one end of the vessel 101, opposite the gas inlet 102/outlet 104 that connects the vessel 101 to the gas system 120 via a valve 118. The valve 118 may be manual or removable and can be controlled to shut off or start the gas supply from the gas system 120.

FIG. 2B depicts an exemplary gas system 120 that is shared among different gas supplies and devices. The gas system 120 is connected to a pressure transducer 202, various gas supplies 204, 206, and 208, a pump system 210, and a Residual Gas Analyzer (RGA) 212. The pressure transducer 202 is configured to measure the pressure of the gas being supplied to the exothermic reactor 100. The pressure readings of the pressure transducer 202 reflect the internal pressure inside the vessel 101 when an approximate equilibrium is reached between the vessel 101 and one of the gas supplies. A number of gas supplies can be connected to the gas system 120. For instance, in FIG. 2B, the gas supply 204, 206, 208 are connected to the gas system 120 to supply He, D₂, or H₂, respectively. The pump system 210 is used to evacuate the vessel 101 and to draw a vacuum inside the vessel 101. In some embodiments, the pump system 210 may comprise a roughing pump 222, an ION gauge 224, and a turbo-molecular pump 226. In some embodiments, the pump system 210 is configured to provide a vacuum ranging from 10 kPa to 10⁻⁵ Pa.

The exothermic reactor system 200 can be configured for excess heat generation. A calorimetrical system is generally employed to measure the heat generation rate that is output by the exothermic reactor system 200. In some embodiments, a flow calorimeter may be employed to measure the output of the reactor system 200. Examples of a flow calorimeter include the water cooling calorimeter 230 shown in FIG. 2D and the gas flow calorimeter 240 shown in FIG. 2E.

As depicted in FIG. 2D, the exothermic reactor 100 is enclosed in the insulation layer 231 of the calorimeter 230. A water tube 232, e.g., a copper or plastic tube, is wrapped around the reactor 100. The water tube 232 is connected to a water reservoir 236 and a circulation pump 234. The circulation pump 234 drives the cooling water through the water tube 232. As the water circulates through the water tube 232, it is heated by the exothermic reactor 100. Two thermocouples T1 and T2 measure the temperature difference between the water inflow and the water outflow. A flow meter 238 measures the volume or weight of the water that has been circulated through the calorimeter 230 within a certain time period. Once an equilibrium state is reached, the amount of energy absorbed by the circulating water equals the amount heat generated by the exothermic reactor 100 and the water cooling calorimeter 230 provides power output measurements of the reactor 100.

A gas flow calorimeter 240 is depicted in FIG. 2E. The exothermic reactor is enclosed in the insulation layer 241, e.g., an epoxy glass container. The gas flow calorimeter 240 is equipped with a gas inlet 246 and a gas outlet 248. A circulation pump 242 connected to the gas outlet 248 forces the gas flow inside the calorimeter 240. A flow meter 244 measures the gas flow rate. The thermocouples T1 and T2 measure the temperature of the inflow gas and that of outflow gas. The temperature difference between the inflow and outflow gas reflects the amount heat absorbed by the gas flow as it is heated by the exothermic reactor 100. The power output of the reactor 100 can be determined from the temperature difference between T1 and T2 and the flow rate measured by the flow meter 244.

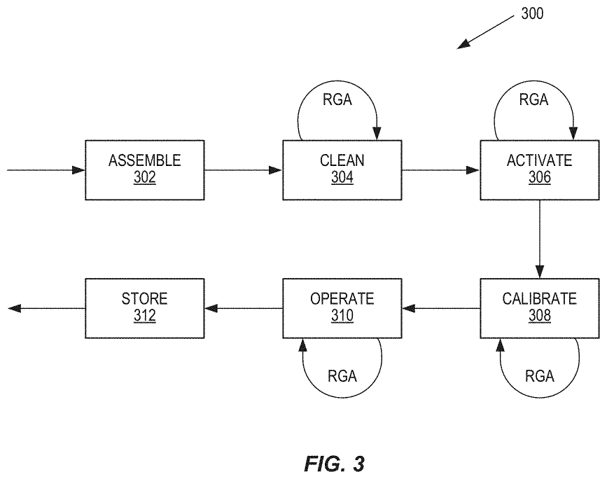

The exothermic reactor 100 is configured for excess heat generation. FIG. 3 illustrates an exemplary process for configuring, preparing, and running the reactor 100. In FIG. 3, the exothermic reactor 100 is first assembled in step 302. The assembled reactor 100 is then cleaned (step 304), activated (step 306), and calibrated (step 308) in preparation for operation. Once ready, the reactor 100 can operate as a heating source or energy generator for an extended time (step 312). When the reactor 100 is ready to retire, it can be transferred into storage after being properly disassembled (step 312).

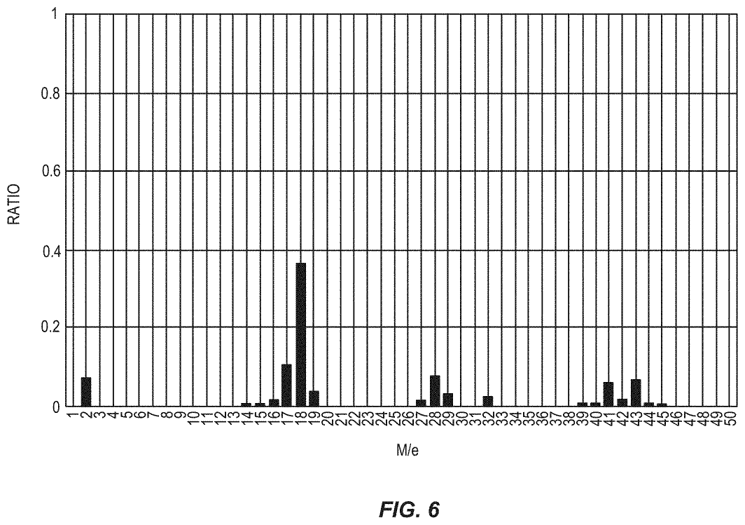

As shown in FIG. 3, during the cleaning, activating, calibrating, and operating steps, real-time RGA analysis is performed to ensure that each of the steps are carried out to completion. In real-time RGA analysis, samples of the gas inside the vessel 101 are collected and analyzed. The results of the RGA analysis can reveal the gas composition of the samples and can confirm the presence or absence of certain impurities or reactant gases. At different steps, different RGA results are expected. More detailed explanation of RGA analysis and results can be found in FIG. 6 and related description.

Past experiments have shown that the precise performance of each step as instructed and the completion of each step as verified by RGA analysis are integral to the success of the operation of the exothermic reactor system 200. The preparation of the reactor 100 involves cleaning and degassing in order to remove impurities such as oxygen, carbon, nitrogen, water, etc. As detailed below, some of the steps require drawing a vacuum inside the vessel 101. Different steps call for different types of vacuum, for example, a low or high vacuum. The following table lists the pressure range for different types of vacuum as generally known in the art.

TABLE 1

| | |
|---|---|
| Low Vacuum | 1 atm-10⁻² atm |
| Medium Vacuum | 10⁻² atm-10⁻⁶ atm |
| High Vacuum | 10⁻⁶ atm-10⁻¹² atm |

Starting with the assembling of the exothermic reactor 100, the system, including the vessel 101, the nickel rod 108, the palladium wire 110, the nickel mesh 106, the pipes and valves, etc., is washed with detergent to reduce oxygen and nitrogen contamination. In some embodiments, coating the interior components of the reactor 100 with platinum can accelerate the cleaning time. The objective of the washing step is to remove both contaminations and impurities, such as oxygen, CHx compounds, water, hydrogen and nitrogen. After the components are washed with detergent, they are cleaned with ethyl alcohol and then acetone. While the components are still wet, they are assembled into the reactor system 100. A low to medium vacuum is drawn to dry the system 100. In one embodiment, the pressure inside the system 100 is reduced to 0.2 Pa. In some embodiments, the system's capability to maintain a vacuum is tested by reducing the pressure to a high vacuum level.

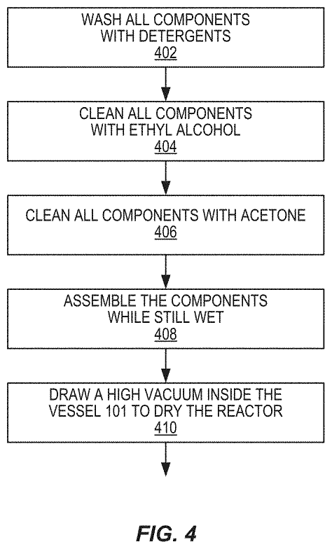

FIG. 4 illustrates an exemplary method for assembling the system 100. In step 402, all components are washed with detergents. They are then cleaned with ethyl alcohol (step 404) and acetone (step 406). The clean components are then assembled into the system 100 while they are still wet (step 408). To dry the system 100, a vacuum, e.g., 10⁻² Pa, is drawn to remove water or moisture (step 410).

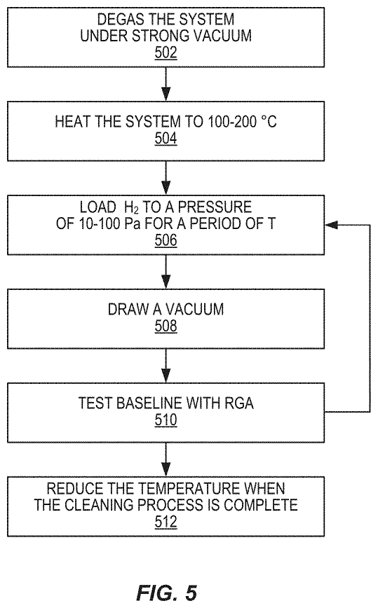

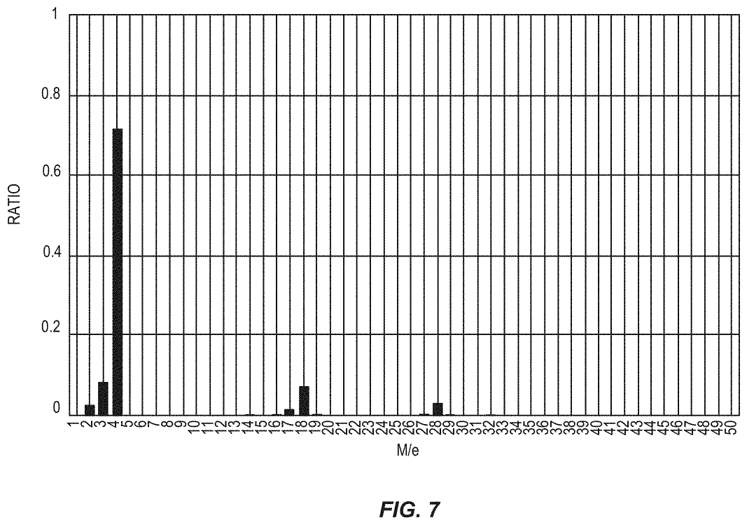

After the system 100 is dried, it is further cleaned through an exemplary cleaning procedure 500 illustrated in FIG. 5. In the cleaning procedure 500, the system 100 is first degassed under a high vacuum (step 502). Under the high vacuum, the system 100 is heated up to 100-200° C. (step 504). While the temperature is maintained at 100-200° C., the system 100 is loaded with H₂ to a pressure of 10-100 Pa. The hydrogen gas is maintained for a period time, e.g., several hours to a day (step 506). The contaminant gases such as nitrogen and oxygen are drawn out from the interior surface of the system 100. To rid of the contaminant gases, the system 100 is evacuated to a vacuum up to, e.g., 10⁻² Pa (step 508). At this point, to determine whether the cleaning procedure is complete, an RGA or a quadrupole mass spectrometry test is performed to measure the level of the contaminant gases inside the system 100. FIGS. 6 and 7 illustrate an exemplary results from an RGA analysis.

An RGA analyzer can measure the abundance of different molecules as identified by atomic mass unit. A mass spectrometer, e.g., a quadrupole mass spectrometer, is a similar device that also can be used to measure a gas composition. In FIG. 6, the RGA graph shows the composition of a background gas. In the background gas, the following chemicals are present: H₂⁺, N₂⁺, P⁺, O₂⁺, Cl⁻, H₂O⁺, K⁺ Co⁺, Ni⁺, Cu⁺, Ge⁺ and trace amounts of a few other rare metals. The RGA graph shows the levels of various contaminations and impurities. When the RGA results indicate that the amount of water and other contaminants are below the required levels, for instance, 10⁻⁸, the system 100 is ready for activation. The RGA results can be relied on as an indicator of the readiness of the system 100 for activation.

As a comparison, FIG. 7 illustrates the composition of a deuterium gas sample that is relatively free of contaminants and impurities. For example, the deuterium gas sample contains little amount of N₂, O₂, and Ni, and no other contaminants or impurities. In the sample gas, the predominant component is D₂⁺. There is also a small amount of H₂⁺ DH⁺(at M/e=3). During activation, the electrodes are connected to a high voltage power supply. After activation, the reactor is calibrated before putting into operation. Alternatively, calibration can be performed before activation. In one embodiment, during calibration, the vessel in the apparatus is degassed first. The vessel is then filled with a helium gas to a first pressure and heated to a plurality of test temperatures. Under each test temperature, the pressure is measured and recorded. When the calibration is finished, the helium gas is evacuated. In other embodiments, argon or vacuum may be used for calibration. In yet another embodiment, calibration is carried out in the flow of a calibration gas, e.g., argon, helium, or hydrogen. Similar to the cleaning step, the gas or gases in the reactor are extracted for RGA analysis during the steps of activation, calibration and/or operation to ensure that each step is carried out to completion.

Once in operation, the reactor may operate as an energy source for months or years. When it is time to terminate the operation, the reactor can be turned off. The reactor can be backfilled with argon to flush out the reactant gas or residual gas and to protect the materials inside the vessel.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. An apparatus for generating excess heat, comprising:
a vessel with a gas inlet for supplying one or more gases and a gas outlet for gas evacuation;
an anode; and
a cathode;
wherein a power supply is connected to the anode and the cathode to maintain a pre-determined voltage differential between the anode and the cathode,
wherein the cathode is made of a first transition metal and the anode is made of a second transition metal that is wound with a third transition metal wire, and
wherein, when the apparatus is in operation, the vessel is filled with a deuterium gas of a pre-determined pressure.

2. The apparatus of claim 1, wherein the cathode is in the shape of a mesh, and wherein the anode is in the shape of a rod made of the second transition metal and wound with the third transition metal wire.

3. The apparatus of claim 1, wherein the first transition metal is nickel.

4. The apparatus of claim 1, wherein the second transition metal is nickel.

5. The apparatus of claim 1, wherein the third transition metal is palladium.

6. The apparatus of claim 1, wherein the pre-determined pressure is approximately 100 Pa.

7. The apparatus of claim 1, wherein the pre-determined voltage differential is zero.

8. The apparatus of claim 1, wherein, during preparation, the vessel is maintained at a pre-determined temperature, and the third transition metal is deposited on the cathode via a deposition process to form a metallic structure.

9. The apparatus of claim 8, wherein the metallic structure is a thin film.

10. The apparatus of claim 8, wherein the metallic structure comprises a plurality of nanoparticles.

11. The apparatus of claim 8, wherein the deposition process is a vapor deposition method.

12. The apparatus of claim 8, wherein the pre-determined temperature is above the curie temperature of the metallic structure.

13. The apparatus of claim 1, wherein the first transition metal is one or more of the following metals: Ti, Ni, Pd, Pt, or an alloy thereof.

14. The apparatus of claim 1, wherein the second transition metal is Ti, Ni, Pd, Pt, or an alloy thereof.

15. The apparatus of claim 3, wherein the nickel rod is approximately 3.2 mm in diameter and 250 mm in length.

16. The apparatus of claim 5, wherein the palladium wire is approximately 0.3 mm in diameter and 2 m in length.

17. The apparatus of claim 4, wherein the nickel mesh is approximately 100 nm.

18. The apparatus of claim 17, wherein the distance between the palladium wire and the nickel mesh is approximately 50 mm.

19. The apparatus of claim 1, wherein the interior of the vessel, the nickel rod, and the nickel mesh are coated with platinum.

20. The apparatus of claim 1, further comprising a heating type wrapped around the vessel.

21. The apparatus of claim 18, wherein the power supply connected to the anode and cathode is a high voltage power supply and wherein the high voltage power supply is configured to produce plasma discharge in the vessel during activation of the apparatus.

22. The apparatus of claim 1, further comprising a shared gas supply system configured to supply helium, hydrogen, or deuterium to the apparatus.

23. The apparatus of claim 1, further comprising a pump system configured to evacuate the vessel to a pre-determined vacuum level.

24. A method of preparing an exothermic reactor for operation, the exothermic reactor comprising a vessel, an anode, and a cathode, the method comprising:
cleaning the exothermic reactor by loading the system with a hydrogen gas;
reducing the exothermic reactor to a strong vacuum;
loading the exothermic reactor with a deuterium gas; and
activating the exothermic reactor for operation by initiating a glow discharge for a period of time.
